(19) United States
(12) Patent Application Publication
(10) Pub. No.: US 2012/0113331 A1
(43) Pub. Date: May 10, 2012

(54) EDGE LIGHT TYPE ILLUMINATING DEVICE, LIQUID CRYSTAL DISPLAY DEVICE, TELEVISION RECEIVER, AND METHOD FOR MANUFACTURING EDGE LIGHT TYPE ILLUMINATING DEVICE

(75) Inventor: Yoshiki Takata, Osaka (JP)

(73) Assignee: SHARP KABUSHIKI KAISHA, Osaka (JP)

(21) Appl. No.: 13/382,445

(22) PCT Filed: Mar. 31, 2010
(86) PCT No.: PCT/JP2010/055860

§ 371 Date: Jan. 5, 2012

(30) Foreign Application Priority Data
Jul. 30, 2009 (JP) 2009-177751

(51) Int. Cl. H04N 3/14; G02F 1/13357; B32B 37/14; G09F 13/18

(52) U.S. Cl. 348/790; 362/602; 349/65; 156/60; 348/E05.133

(57) ABSTRACT

Provided is an edge light type illuminating device and the like that can suppress uneven brightness even when a reflective sheet is warped. The edge light type illuminating device includes a light source 2, a substantially transparent light guide plate 3 that is disposed with an end surface 13 thereof facing the light source 2 and that allows light that has entered through the end surface 13 to travel while reflecting repeatedly off a front surface 23 and a rear surface 33, a plurality of scattering sections 4 that are dispersedly disposed over the rear surface 33 of the light guide plate 3 and that scatter the light that has entered through the end surface 13 of the light guide plate 3, causing the light to go out through the front surface, and a reflective sheet 5 that is disposed on the rear surface 33 side of the light guide plate 3 and that reflects light leaking from areas of the rear surface 33 where the scattering sections 4 are not provided. The device also includes a transparent layer 8 that covers the scattering sections 4 on the rear surface 33 of the light guide plate 3.

### TECHNICAL FIELD

The present invention relates to an edge light type illuminating device, a liquid crystal display device, a television receiver, and a method of manufacturing an edge light type illuminating device.

### BACKGROUND ART

In recent years, liquid crystal display devices are used for a display section of various electronic devices such as personal computers, mobile phones, video cameras, and televisions. This type of liquid crystal display device generally includes a liquid crystal panel that displays an image and an illuminating device that illuminates this liquid crystal panel. The liquid crystal panel is constituted of a pair of substrates and a liquid crystal material sandwiched therebetween. Because the panel itself does not produce light and cannot display an image by itself, the illuminating device that illuminates the liquid crystal panel is provided in the liquid crystal display device as described above.

There are two types of illuminating devices that are primarily known: an area light type (direct light type) in which a light source is disposed directly below a liquid crystal panel; and an edge light type in which a light source is disposed at an end portion of a light guide plate of an illuminating device. Between the two, the illuminating device of the edge light type (edge light type illuminating device hereinafter) has been attracting attention in recent years because of the advantages such as providing a thinner liquid crystal display device as compared with the direct light type.

FIG. 6 is an explanatory diagram that schematically shows a cross-section of a conventional edge light type illuminating device 1P. As shown in FIG. 6, the edge light type illuminating device 1P includes a light source 2P constituted of a cold-cathode tube or the like, a substantially transparent light guide plate 3P that is disposed such that an end surface 13P thereof faces the light source 2P, a plurality of scattering sections 4P that are dispersedly disposed over a rear surface 33P of the light guide plate 3P, and a reflective sheet 5P disposed on the rear surface 33P side of the light guide plate 3P.

As shown in FIG. 6, in the edge light type illuminating device 1P, light 6P from the light source 2P that has entered the light guide plate 3P through the end surface 13P travels inside of the light guide plate 3P while repeatedly reflecting off a front surface 23P and the rear surface 33P of the light guide plate 3P. Because of the reflective sheet 5P that is disposed so as to make contact with the rear surface 33P of the light guide plate 3P, the light 6P is efficiently reflected from the rear surface 33P. Part of the incident light is scattered by the scattering sections 4P of the rear surface (bottom surface) 33P of the light guide plate 3P, and part of the scattered light 16P goes out through the front surface 23P. This causes relatively more light to go out from the scattering sections 4P and the nearby areas of the light guide plate 3P, thereby making them look brighter as compared with other areas (of the rear surface 33P) where the scattering sections 4P are not disposed.

Although not shown in FIG. 6, the edge light type illuminating device 1P includes an optical sheet on the front surface 23P side of the light guide plate 3P so as to adjust optical characteristics of light going out through the front surface 23P of the light guide plate 3P. Here, for ease of explanation, light coming out through the front surface 23P of the light guide plate 3P is observed from above the light guide plate 3P without the optical sheet.

In this kind of edge light type illuminating device 1P, uneven brightness can be caused by warping (wrinkle) of the reflective sheet 5P. The uneven brightness is an image quality defect where bright sections and dark sections alternately appear on a display surface of a liquid crystal panel, which is difficult to eliminate even when the optical sheet is disposed to adjust the optical characteristics of light.

The cause of the uneven brightness will be explained with reference to FIG. 7. FIG. 7 is an explanatory diagram schematically showing a cross-section of the conventional edge light type illuminating device 1P in which the reflective sheet 5P is warped. As shown in FIG. 7, the reflective sheet 5P disposed on the rear surface 33P side of the light guide plate 3P is deformed and warped, thereby creating areas (S1 and S3) having a larger gap between the sheet and the rear surface 33P of the light guide plate 3P, and an area (S2) in which the gap is smaller. Warping of the reflective sheet 5P can result from various causes such as heat and the gravity on the reflective sheet.

As shown in FIG. 7, in the area (S2) having the smaller gap, light that has entered through the end surface 13P is scattered by the scattering section 4P of the rear surface 33P, and part of the scattered light 16P goes out through the front surface 23P. Also, in the area (S2) having the smaller gap, light that has entered through the end surface 13P is reflected by the reflective sheet 5P in areas of the rear surface 33P where the scattering sections 4P are not disposed.

In contrast, as shown in FIG. 7, in the area (S1) having the larger gap, light that has entered through the end surface 13P strikes the scattering section 4P of the rear surface 33P and is thereby scattered, causing part of the scattered light 16P to go out through the front surface 23P. At the same time, other light 26P goes out through the front surface 23P. This light 26P is mainly generated by the gap formed between the rear surface 33P of the light guide plate 3P and the reflective sheet 5P. As shown in FIG. 7, when the reflective sheet 5P is separated from the light guide plate 3P and a gap is created between the rear surface 33P of the light guide plate 3P and the reflective sheet 5P, it allows light to exit the light guide plate 3P from the rear surface 33P side. The light that exited from the rear surface 33P side is reflected by the front surface of the warped reflective sheet 5P. The reflected light re-enters the light guide plate 3P through the rear surface 33P and thereafter goes out through the front surface 23P of the light guide plate 3P as light 26. This means that, when the reflective sheet 5P is warped, more light goes out through the front surface 23P of the light guide plate 3P, and as a result, even the areas of the rear surface 33P not provided with the scattering sections 4P look bright. Similarly, in the other area (S3) having the larger gap, the areas of the rear surface 33P not provided with the scattering sections 4P look bright.

That is, when the reflective sheet 5P is warped as shown in FIG. 7, the areas (S1 and S3) having the larger gap between the rear surface 33P of the light guide plate 3P and the reflective sheet 5P have more reflection light from the reflective sheet 5P and the like, and therefore, look brighter than the area (S2) having the smaller gap. This results in the uneven brightness in these areas (S1, S2, and S3).

Conventional edge light type illuminating devices that are designed to suppress this uneven brightness include the devices disclosed in Patent Documents 1 and 2, for example. The edge light type illuminating devices described therein both have projections (protruding portions) formed on the rear surface of the light guide plate. By these projections, the reflective sheet is adhered to the rear surface of the light guide plate in places, thereby suppressing warping of the reflective sheet.

### Related Art Documents

### Patent Documents

Patent Document 1: Japanese Patent Application Laid-Open Publication No. 2004-253367

Patent Document 2: Japanese Patent Application Laid-Open Publication No. 2005-32723

### SUMMARY OF THE INVENTION

### Problems to be Solved by the Invention

Although the edge light type illuminating devices described in Patent Documents 1 and 2 makes the warping (wrinkle) of the reflective sheet less likely to occur, it is not possible to completely prevent the warping of the reflective sheet even with these devices.

In an edge light type illuminating device that is used for a large liquid crystal display device, for example, a reflective sheet of the edge light type illuminating device also becomes large in size and mass. When this liquid crystal display device (a television receiver, for example) is placed and used such that the display surface becomes substantially perpendicular to the horizontal plane, the reflective sheet in the edge light type illuminating device also becomes substantially perpendicular thereto. This makes the reflective sheet, the lower side in particular, more likely to warp due to its own weight (gravity). In this case, even the edge light type illuminating devices described in Patent Documents 1 and 2 cannot completely prevent the reflective sheet from warping.

In the edge light type illuminating devices described in Patent Documents 1 and 2, once the reflective sheet is warped, the uneven brightness is caused by the warping, resulting in uneven display of the liquid crystal display device.

It is an object of the present invention to provide an edge light type illuminating device and the like that can suppress uneven brightness even when a reflective sheet is warped.

### Means for Solving the Problems

An edge light type illuminating device according to the present invention is as follows:

(1) An edge light type illuminating device that illuminates a liquid crystal panel from a rear surface thereof, including:

a light source;

a substantially transparent light guide plate with an end surface facing the light source, the substantially transparent light guide plate allowing light that has entered through the end surface to travel while repeatedly reflecting off a front surface and a rear surface thereof;

a plurality of scattering sections disposed dispersedly over the rear surface of the light guide plate to scatter the light that has entered through the end surface of the light guide plate, causing the light to go out through the front surface;

a reflective sheet disposed on a side of the rear surface of the light guide plate to reflect light leaking from areas of the rear surface where the scattering sections are not disposed; and

a transparent layer covering the scattering sections on the rear surface of the light guide plate.

(2) The edge light type illuminating device described in (1) above, wherein the light guide plate and the transparent layer are made of the same material.

(3) The edge light type illuminating device described in (1) or (2) above, wherein the transparent layer is thinner than the light guide plate.

(4) The edge light type illuminating device described (1) above, wherein the device is manufactured by bonding a transparent sheet having the plurality of scattering sections formed on a surface thereof to the rear surface of the substantially transparent light guide plate.

A method of manufacturing an edge light type illuminating device according to the present invention is as described below.

(5) A method of manufacturing an edge light type illuminating device that illuminates a liquid crystal panel from a rear surface thereof, the edge light type lighting device, the edge light type illuminating device including:

a light source;

a substantially transparent light guide plate with an end surface thereof facing the light source, the substantially transparent light guide plate allowing light that has entered through the end surface to travel while repeatedly reflecting on a front surface and a rear surface thereof;

a plurality of scattering sections disposed dispersedly over the rear surface of the light guide plate to scatter the light that has entered through the end surface of the light guide plate, causing the light to go out through the front surface;

a reflective sheet disposed on a side of the rear surface of the light guide plate to reflect light leaking from areas of the rear surface where the scattering sections are not disposed; and

a transparent layer covering the scattering sections on the rear surface of the light guide plate, the method including:

a step of bonding a transparent sheet having a plurality of the scattering sections formed on a surface thereof to the rear surface of the substantially transparent light guide plate.

(6) The method of manufacturing an edge light type illuminating device described in (5) above, wherein the scattering sections are formed on the transparent sheet by silk printing.

(7) The method of manufacturing an edge light type illuminating device described in (5) above, wherein the scattering sections are formed on the transparent sheet by gravure printing.

(8) The method of manufacturing an edge light type illuminating device described in (5), wherein the scattering sections are formed on the transparent sheet by relief printing.

(9) The method of manufacturing an edge light type illuminating device described in (5) above, wherein the scattering sections are formed on the transparent sheet by offset printing.

(10) The method of manufacturing an edge light type illuminating device described in (5) above, wherein the scattering sections are formed on the transparent sheet by inkjet printing.

A liquid crystal display device according to the present invention is as described below.

(11) A liquid crystal display device, including:

a liquid crystal panel; and

the edge light type illuminating device described in any one of (1) to (4) above, or an edge light type illuminating device that is manufactured by the method of manufacturing an edge light type illuminating device described in any one of (5) to (10) above.

A television receiver according to the present invention is described as below.

(12) A television receiver including the liquid crystal display device described in (11) above.

### Effects of the Invention

According to the edge light type illuminating device of the present invention, uneven brightness can be suppressed even when the reflective sheet is warped.

According to the liquid crystal display device including the edge light type illuminating device of the present invention, uneven brightness can be suppressed even when the reflective sheet is warped.

According to the television receiver including the liquid crystal display device of the present invention, uneven brightness can be suppressed even when the reflective sheet is warped.

According to the method of manufacturing the edge light type illuminating device of the present invention, an edge light type illuminating device that can suppress uneven brightness even when the reflective sheet is warped can be manufactured efficiently.

### BRIEF DESCRIPTION OF THE DRAWINGS

FIG. 1 is an exploded perspective view showing a schematic configuration of a liquid crystal display device according to one embodiment.

FIG. 2 is a cross-sectional view of the liquid crystal display device along the line A-A′ in FIG. 1.

FIG. 3 is an explanatory diagram schematically showing a cross-section of a part of an edge light type illuminating device.

FIG. 4 is an explanatory diagram showing a step of forming a transparent layer on the light guide plate by bonding a transparent sheet having scattering sections printed on the surface thereof to a rear surface of a light guide plate.

FIG. 5 is an exploded perspective view showing a schematic configuration of a television receiver according to one embodiment.

FIG. 6 is an explanatory diagram schematically showing a cross-section of a conventional edge light type illuminating device.

FIG. 7 is an explanatory diagram schematically showing a cross-section of a conventional edge light type illuminating device having a warped reflective sheet.

### DETAILED DESCRIPTION OF EMBODIMENTS

Embodiments of an edge light type illuminating device and a liquid crystal display device according to the present invention will be explained below with reference to figures. The present invention, however, is not limited to the embodiments exemplified in the present specification.

Liquid Crystal Display Device

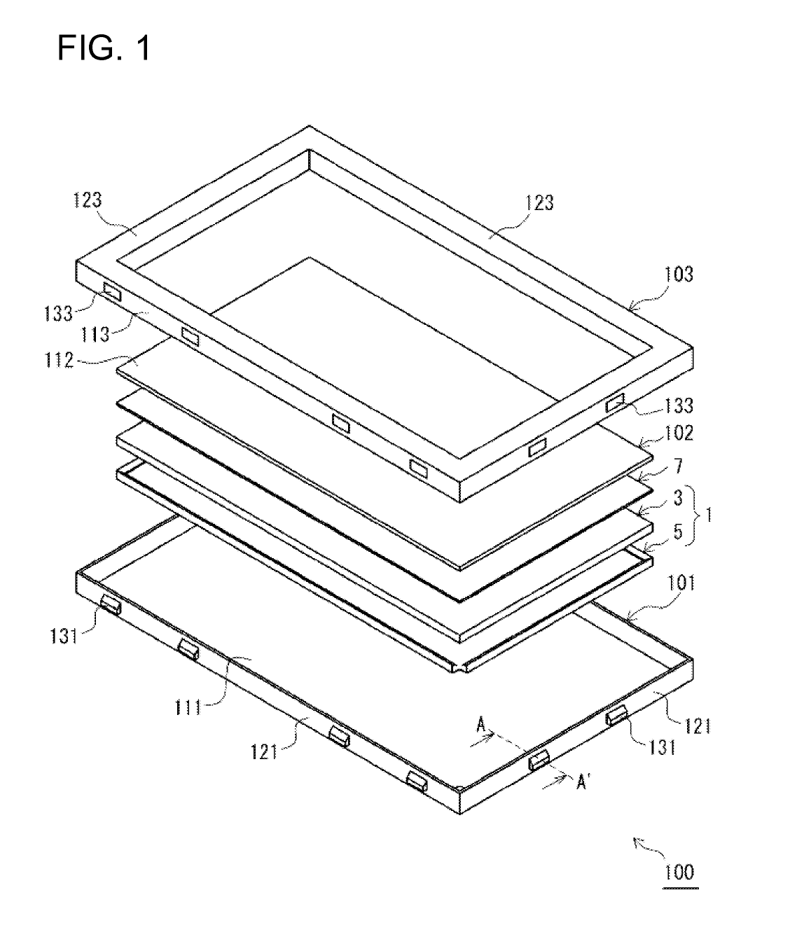

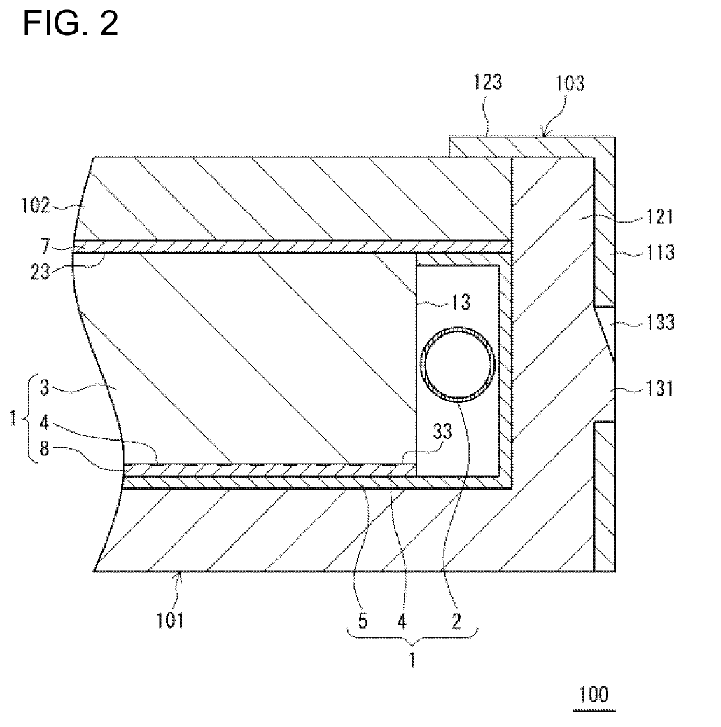

FIG. 1 is an exploded perspective view showing a schematic configuration of a liquid crystal display device 100 according to one embodiment of the present invention. FIG. 2 is a cross-sectional view of the liquid crystal display device 100 along the line A-A′ in FIG. 1. As shown in FIG. 1, the liquid crystal display device 100 includes a chassis 101, a reflective sheet 5, a light guide plate 3, an optical sheet 7, a liquid crystal panel 102, and a bezel 103. The liquid crystal display device 100 also includes a light source 2 as shown in FIG. 2. The light source is not shown in FIG. 1 for ease of explanation.

The chassis 101 is constituted of a shallow box including a substantially rectangular bottom 111 and outer walls 121 that are extended upward from the bottom 111 so as to enclose the bottom 111. The chassis 101 is made of a known material such as a resin material or a metal material, and contains the reflective sheet 5, the light source 2, the light guide plate 3, the optical sheet 7, and the liquid crystal panel 102 therein. As shown in FIGS. 1 and 2, the reflective sheet 5, the light guide plate 3, the optical sheet 7, and the liquid crystal panel 102 are laminated in this order inside of the chassis 101 so that the liquid crystal panel 102 is placed topside (outer side). The outer wall 121 of the chassis 101 has a plurality of protruding portions 131 on the outer wall surface thereof.

The bezel 103 is a frame-shape member made of a known material such as a metal material. The bezel 103 is placed over and secured to the chassis 101 containing a laminated body that includes the reflective sheet 5 and the like. The bezel 103 is constituted of a frame wall portion 113 that covers the outer wall surface of the outer wall 121 of the chassis 101, and a frame roof portion 123 that covers an upper end surface of the outer wall 121 and a surface of edges of the liquid crystal panel 102 contained in the chassis 101. The frame wall portion 113 has a plurality of recessed portions (openings) 133. The protruding portions 131 formed on the outer wall 121 of the chassis 101 engage these recessed portions 133, respectively, thereby securing the bezel 103 to the chassis 101. When the bezel 103 is secured to the chassis 101, the above-mentioned laminated body is pushed against the bottom 111 of the chassis 101 by the frame roof portion 123 of the bezel 103 and is retained inside of the chassis 101 by the pressure.

The liquid crystal panel 102 is constituted of a thin film transistor (TFT) array substrate, a color filter (CF) substrate, and a liquid crystal layer sandwiched therebetween, and does not produce light by itself. The liquid crystal panel 102 is placed inside of the chassis 101 with an image display surface 112 thereof facing upward. The liquid crystal panel 102 is illuminated by light emitted from an edge light type illuminating device 1 described below from a surface on the opposite side (rear surface) of the image display surface 112.

Edge Light Type Illuminating Device

As shown in FIGS. 1 and 2, the liquid crystal display device 100 includes the edge light type illuminating device 1. This edge light type illuminating device 1 is disposed on the rear surface side of the liquid crystal panel 102 and is equipped with the light source 2, the light guide plate 3, the reflective sheet 5, and the like.

The light source 2 is constituted of a rod-shape cold-cathode tube and is disposed along the inner wall surface of the outer wall 121 of the chassis 101. The light source 2 is disposed along an end surface 13 of the light guide plate 3 as well, and can therefore emit light toward the end surface 13 of the light guide plate 3.

In other embodiments, a known light source such as a white light-emitting diode or a fluorescent lamp may be used as the light source 2. Also, the shape of the light source 2 is not limited to a rod shape. It may also be an L-shape, for example, and is suitably selected for the purpose. The light source 2 may be disposed along one end surface of the light guide plate 3, or may be disposed along a plurality of end surfaces. There is no special limitation on the number of the light source 2 to be used as well, and it is suitably selected for the purpose.

The light guide plate 3 is made of a substantially transparent plate that transmits light at least. Acrylic resin such as polymethyl methacrylate (PMMA), polycarbonate (PC) resin, methyl methacrylate styrene copolymer (MS resin), and the like, for example, may be used for the material for the light guide plate 3.

As shown in FIGS. 1 and 2, the light guide plate 3 of the present embodiment is substantially rectangular so as to correspond to the shape of the liquid crystal panel that is substantially rectangular. The thickness of the light guide plate 3 of the present embodiment is substantially uniform.

In other embodiments, there is no special limitation on the shape, the thickness, and the like of the light guide plate 3, and they are suitably selected for the purpose. A plate that becomes progressively thinner from one end surface side to the other end surface side may also be used as the light guide plate 3, for example.

The light guide plate 3 is disposed inside of the chassis 101 such that the end surface 13 faces the light source 2. The light guide plate 3 allows light from the light source 2 that has entered through the end surface 13 to travel in the horizontal direction inside of the plate and go out through the front surface 23 at the same time. The light emitted through the front surface 23 of the light guide plate 3 illuminates the liquid crystal panel 102, which is laminated above the light guide plate 3 inside of the chassis 101, from the rear surface.

On the rear surface 33 of the light guide plate 3, a plurality of scattering sections 4 are formed. These scattering sections 4 are disposed dispersedly over the rear surface 33 of the light guide plate 3. When light that has entered the light guide plate 3 strikes the scattering sections 4, the light scatters in different directions, thereby generating scattered light. Part of this scattered light goes out through the front surface 23 of the light guide plate 3.

The scattering sections 4 of the present embodiment is made of a known material and is formed by printing a paint including a white pigment and the like on the rear surface 33 of the light guide plate 3 in a dotted pattern, for example. As the printing method, silk printing, gravure printing, relief printing, offset printing, inkjet printing, and the like can be employed, for example. In addition to those made of the paint described above, the scattering sections 4 may be constituted of recessed portions (so-called grain) formed by grinding the rear surface 33 of the light guide plate 3, for example.

There is no special limitation on the quantity, shape, color, arrangement pattern, and the like of the scattering sections 4, and they are suitably selected for the purpose.

On the rear surface 33 of the light guide plate 3, a transparent layer 8 is formed. This transparent layer 8 is formed so as to cover the scattering sections 4 formed on the rear surface 33 of the light guide plate 3. Similar to the light guide plate 3, this transparent layer 8 is made of a material that transmits light at least. The transparent layer 3 can be made of the material that is used to make the light guide plate 3, for example. That is, the transparent layer 8 and the light guide plate 3 may be made of the same material. Acrylic resin may be used as the material for both the transparent layer 8 and the light guide plate 3.

Methods for forming the transparent layer 8 on the rear surface 33 of the light guide plate 3 include a method of applying an uncured material such as a thermoplastic resin on the rear surface 33 of the light guide plate 3 to form a coating film, and curing the coating film to make the transparent layer, for example. Another method is to prepare a transparent sheet made of a transparent material such as acrylic resin, bond this transparent sheet onto the rear surface 33 of the light guide plate 3 where the scattering sections 4 are formed, and use this transparent sheet as the transparent layer.

The transparent layer 8 of the present embodiment is constituted of a layer that is laminated on the rear surface 33 of the light guide plate 3 in a substantially uniform thickness. Generally, the thickness of the transparent layer 8 is set to be smaller than the thickness of the light guide plate 3. A function and the like of the transparent layer 8 will be explained later.

The reflective sheet 5 is constituted of a sheet-shape member that has a function of reflecting light, and is disposed below (rear surface 33 side) the light guide plate 3 disposed inside of the chassis 101 of the liquid crystal display device 100. That is, the reflective sheet 5 is interposed between the transparent layer 8 formed on the rear surface 33 of the light guide plate 3 and the bottom surface 111 of the chassis 101. The reflective sheet 5 has a function of reflecting light that comes out from the inside of the light guide plate 3 through the transparent layer 8 formed on the rear surface 33 side so that the reflected light goes back into the light guide plate 3 through the transparent layer 8.

The reflective sheet 5 is made of a foam plastic sheet or the like having a light-reflecting property such as a foam polyethylene terephthalate sheet (hereinafter, a foam PET sheet), for example.

The reflective sheet 5 of the present embodiment is made of a substantially rectangular foam PET sheet, and the end portion thereof is folded back. As shown in FIG. 2, the end portion of the reflective sheet 5 is folded back so as to cover the light source 2 that is disposed to face the end surface 13 of the light guide plate 3. By folding back the end portion of the reflective sheet 5 in such a manner, the utilization efficiency of the light from the light source 2 can be enhanced.

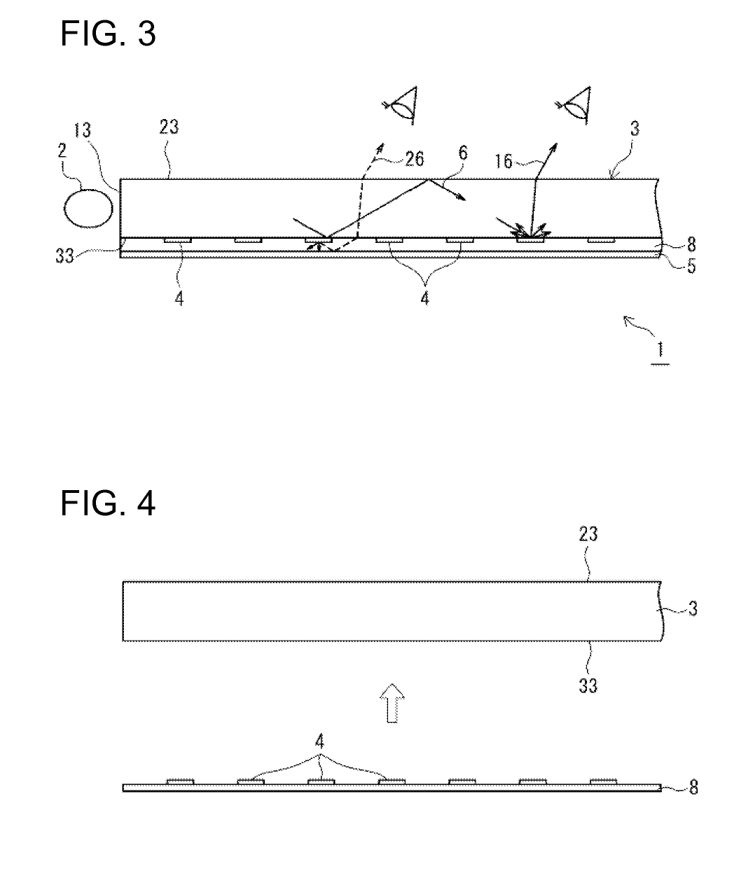

In the edge light type illuminating device 1 of the present embodiment, even when the reflective sheet 5 is warped, the occurrence of uneven brightness caused by the warping can be suppressed. The principle of the suppression of uneven brightness in the edge light type illuminating device 1 will be explained below with reference to figures. FIG. 3 is an explanatory diagram schematically showing a cross-section of a part of the edge light type illuminating device 1. In FIG. 3, the light guide plate 3 is placed such that the light source 2 is placed at the left end and the end surface 13 faces the light source 2. Below the light guide plate 3, the reflective sheet 5 having no warp is disposed so as to make contact with the transparent layer 8 formed on the rear surface 33 of the light guide plate 3. Below the reflective sheet 5, the bottom of the chassis of the liquid crystal display device is disposed, which is not shown in the figure.

On the front surface 23 of the actual light guide plate 3, the optical sheet 7 is laminated as shown in FIGS. 1 and 2, thereby adjusting light from the edge light type illuminating device 1 to uniformly illuminate the liquid crystal panel 102. However, here, the light emitted through the front surface 23 of the light guide plate 3 is observed from above the light guide plate 3 without the optical sheet 7.

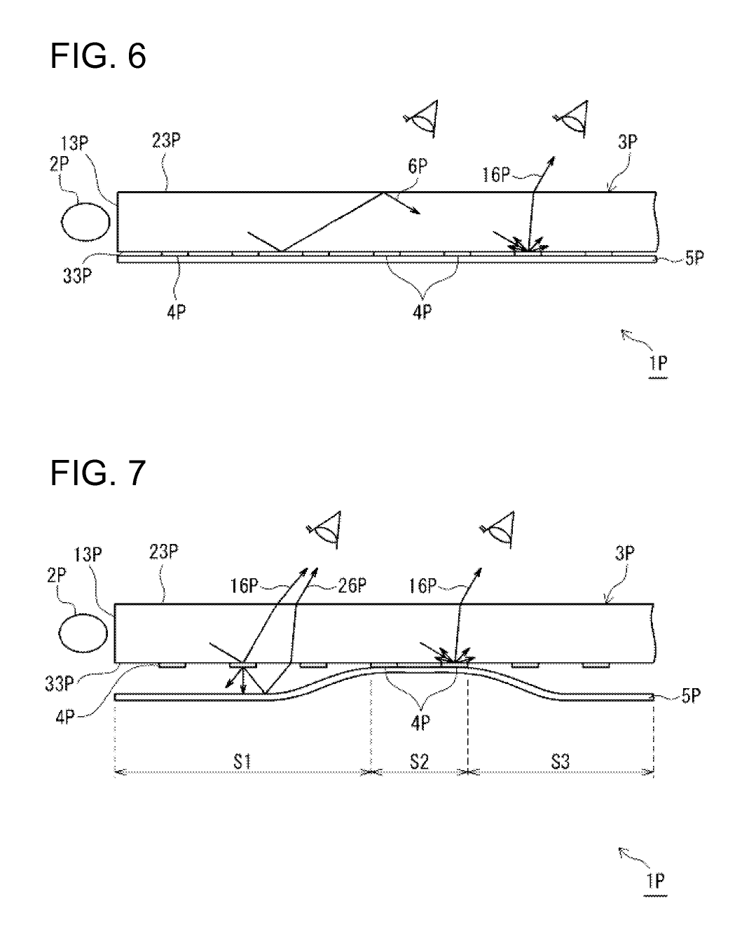

Part of the light 6 that has entered through the end surface 13 travels inside of the light guide plate 3 while repeatedly reflecting off the front surface 23 and the rear surface 33 in a manner similar to the conventional edge light type illuminating device 1P shown in FIG. 6. When light 6 that has entered through the end surface 13 strikes the scattering sections 4 formed on the rear surface 33 of the light guide plate 3, scattered light is generated in a manner similar to the conventional edge light type illuminating device 1P shown in FIG. 6. Part 16 of the scattered light goes out through the front surface 23, thereby making the areas where the scattering sections 6 are formed look bright.

In the edge light type illuminating device 1 of the present embodiment, the transparent layer 8 is formed on the rear surface 33 of the light guide plate 3 so as to cover the scattering sections 4. Therefore, when part of the light that has entered through the end surface 13 reaches the transparent layer 8 through the rear surface 33 of the light guide plate 3, it is reflected by the transparent layer 8 or the reflective sheet 5 disposed below the transparent layer. The reflected light goes back into the light guide plate 3, and part of the reflected light directly goes outside of the light guide plate 3 through the front surface 23. As described above, the transparent layer 8 disposed on the rear surface 33 of the light guide plate 3 allows light to be emitted toward the front surface 23 from the areas of the rear surface 33 where the scattering sections 4 are not formed as well, thereby making these areas not provided with the scattering sections 4 look slightly brighter.

That is, the transparent layer 8 is disposed in the edge light type illuminating device 1 of the present embodiment so that the areas of the rear surface 33 not provided with the scattering sections 4 look slightly brighter than those of the conventional edge light type illuminating device 1P shown in FIG. 6 having no warp in the reflective sheet 5P. As a result, when the reflective sheet 5 is not warped, the overall brightness of the edge light type illuminating device 1 becomes higher than that of the conventional edge light type illuminating device 1P. The brightness of the areas of the rear surface 33 not provided with the scattering sections 4—therefore, the resulting brightness of the edge light type illuminating device 1—can be adjusted by appropriately changing the thickness of the transparent layer 8.

One may presume that in the edge light type illuminating device 1 of the present embodiment as well, the area having a larger gap between the reflective sheet 5 and the transparent layer 8 of the light guide plate 3, which could be created by warping of the reflective sheet 5, would look bright as compared with other areas having no warp (hence having the smaller gap (or no gap)) in a manner similar to the conventional edge light type illuminating device 1P shown in FIG. 7.

Uneven brightness caused by the warping of the reflective sheet 5 is more noticeable as the brightness of the areas looking relatively dark becomes lower. The edge light type illuminating device 1 of the present embodiment is configured such that the area with no warp and therefore having a small gap (or no gap) between the reflective sheet 5 and the transparent layer 8 already looks brighter to some extent. Thus, even when the reflective sheet 5 is warped, the difference in brightness (luminance) between the area in which the gap between the reflective sheet 5 and the transparent layer 8 is widened by the warping and the area in which the gap remains small (or no gap exists) becomes smaller. This makes uneven brightness less noticeable and suppressed.

Referring to FIGS. 1 and 2, the explanation of the liquid crystal display device 1 will be resumed. As shown in FIGS. 1 and 2, the optical sheet 7 is laminated on the front surface 23 of the light guide plate 3. The optical sheet 7 is for adjusting the optical characteristics of light emitted from the edge light type illuminating device 1, and can be constituted of a light control sheet, a diffusion sheet, a prism sheet, and the like, as known in the art. The optical sheet 7 can be constituted of a single sheet or a plurality of sheets that are laminated.

The liquid crystal display device 100 can be used for a display unit of a television receiver, for example. In addition to television receivers, the liquid crystal display device according to the present invention can be used for various liquid crystal display devices (personal computers, mobile phones, video cameras, and the like, for example).

Method of Manufacturing Edge Light Type Illuminating Device

Here, with reference to FIG. 4, a method of manufacturing an edge light type illuminating device according to one embodiment of the present invention will be explained. FIG. 4 is an explanatory diagram showing a step of bonding a transparent sheet having the scattering sections 4 printed on the surface thereof onto the rear surface 33 of the light guide plate 3 so as to form the transparent layer 8 on the light guide plate 3. The method of manufacturing the edge light type illuminating device includes a step of forming, on the rear surface 33 of the light guide plate 3, the transparent layer 8 and the scattering sections 4 simultaneously by using the transparent sheet having the scattering sections 4 printed on the surface thereof as shown in FIG. 4. By using this step, the transparent layer 8 having a substantially uniform thickness can be formed on the rear surface 33 of the light guide plate 3 with ease. This method also makes it easier to control the thickness of the transparent layer 8. Also, this step allows the scattering sections 4 and the transparent layer 8 to be formed simultaneously, thereby enhancing the efficiency.

As the transparent sheet to form the transparent layer 8, a sheet made of the same material as that of the light guide plate 3 such as acrylic resin can be used.

The scattering sections 4 are formed on one surface of this transparent sheet in advance by printing a paint including a white pigment and the like in a dotted pattern with a printing device such as a silk printing device, a gravure printing device, a relief printing device, an offset printing device, or an inkjet printing device. Thereafter, the transparent sheet is bonded and secured to the light guide plate 3 such that the surface having the scattering sections 4 formed thereon makes contact with the rear surface 33 of the light guide plate 3. The transparent sheet and the light guide plate can be secured by pressure bonding, an adhesive agent, or the like.

By using the gravure printing method employing a gravure printing device to form the scattering sections 4 on the transparent sheet, the speed of the in-line manufacturing can be increased as compared to the silk printing method using a silk printing device and like printing method. Also, it makes it easier to perform fine optical adjustments for hue and the like of the scattering sections 4 formed on the transparent sheet.

By using the relief printing method employing a relief printing device to form the scattering sections 4 on the transparent sheet, the speed of the in-line manufacturing can be increased as compared to the silk printing method and the like. Also, it makes it easier to perform fine optical adjustments for hue and the like of the scattering sections 4 formed on the transparent sheet.

By using the offset printing method employing an offset printing device to form the scattering sections 4 on the transparent sheet, the speed of the in-line manufacturing can be further increased as compared to the gravure printing method and the like. Also, because a plate used in the offset printing method to form the scattering sections 4 is inexpensive, the manufacturing cost can be reduced.

By using the inkjet printing method employing an inkjet printing device to form the scattering sections 4 on the transparent sheet, the specification of the scattering sections 4 such as patterns, sizes, and the like can be modified more flexibly.

Television Receiver

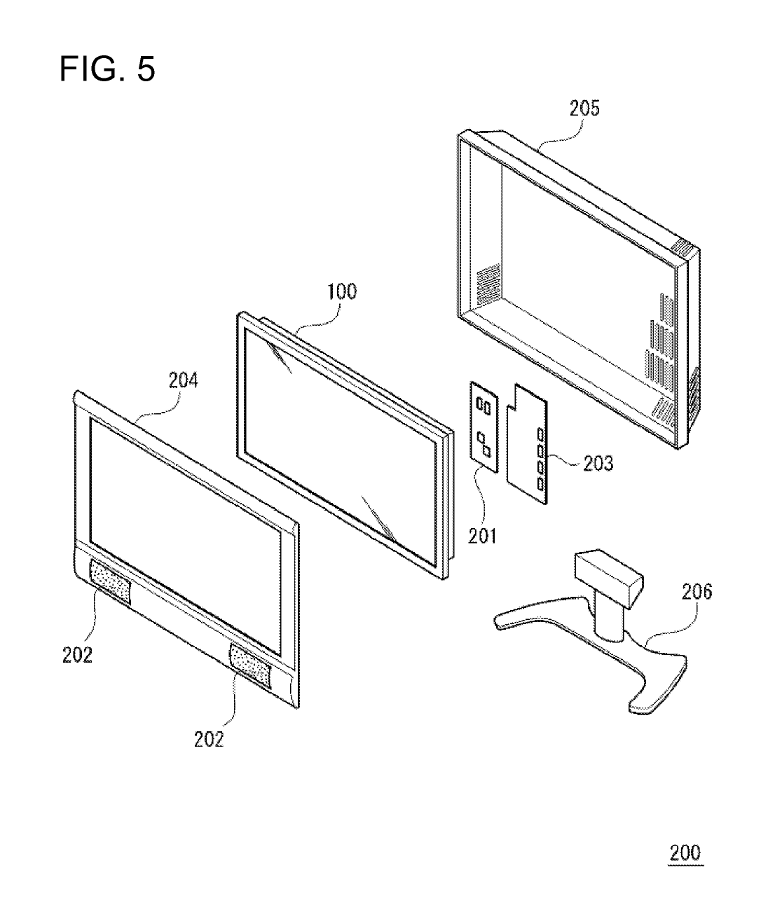

A television receiver according to one embodiment of the present invention will be explained below with reference to FIG. 5. FIG. 5 is an exploded perspective view showing a schematic configuration of a television receiver according to one embodiment. As shown in FIG. 5, a television receiver 200 includes the liquid crystal display device 100, a tuner 201, loudspeakers 202, a power supply 203, a front side cabinet 204, a back side cabinet 205, and a supporting member 206. This television receiver 200 is equipped with the liquid crystal display device 100 including the edge light type illuminating device 1.

The tuner 201 generates image signals and audio signals of a prescribed channel based on received radio waves. Conventional ground wave tuners (an analog ground wave tuner, a digital ground wave tuner, or both of them), a BS tuner, a CS tuner, or the like can be used as this tuner 201.

The loudspeakers 202 produce sounds based on the audio signals generated by the tuner 201. General speakers or the like can be used as these loudspeakers 202.

The power supply 203 supplies power to the liquid crystal display device 100, the tuner 201, the loudspeakers 202, and the like.

The liquid crystal display device 100, the tuner 201, the loudspeakers 202, and the power supply 203 are sandwiched by the front side cabinet 204 and the back side cabinet 205 and are enclosed therein. The liquid crystal display device 100 and the like enclosed in the front side cabinet 204 and the back side cabinet 205 are supported by the supporting member (so-called stand) 206.

The television receiver of the present embodiment is equipped with the liquid crystal display device including the edge light type illuminating device having the transparent layer formed on the rear surface of the light guide plate, and therefore, even when the reflective sheet of the edge light type illuminating device is warped, uneven brightness is suppressed.

1. An edge light type illuminating device that illuminates a liquid crystal panel from a rear surface thereof, comprising:
a light source;
a substantially transparent light guide plate with an end surface facing the light source, the substantially transparent light guide plate allowing light that has entered through the end surface to travel while repeatedly reflecting off a front surface and a rear surface thereof;
a plurality of scattering sections disposed dispersedly over the rear surface of the light guide plate to scatter the light that has entered through the end surface of the light guide plate, causing the light to go out through the front surface;
a reflective sheet disposed on a side of the rear surface of the light guide plate to reflect light leaking from areas of the rear surface where the scattering sections are not disposed; and
a transparent layer covering the scattering sections on the rear surface of the light guide plate.

2. The edge light type illuminating device according to claim 1, wherein the light guide plate and the transparent layer are made of a same material.

3. The edge light type illuminating device according to claim 1, wherein the transparent layer is thinner than the light guide plate.

4. The edge light type illuminating device according to claim 1, wherein the device is manufactured by bonding a transparent sheet having the plurality of scattering sections formed on a surface thereof to the rear surface of the substantially transparent light guide plate.

5. A method of manufacturing an edge light type illuminating device that illuminates a liquid crystal panel from a rear surface thereof, the edge light type illuminating device comprising:
a light source;
a substantially transparent light guide plate with an end surface facing the light source, the substantially transparent light guide plate allowing light that has entered through the end surface to travel while repeatedly reflecting off a front surface and a rear surface thereof;
a plurality of scattering sections disposed dispersedly over the rear surface of the light guide plate to scatter the light that has entered through the end surface of the light guide plate, causing the light to go out through the front surface;
a reflective sheet disposed on a side of the rear surface of the light guide plate to reflect light leaking from areas of the rear surface where the scattering sections are not disposed; and
a transparent layer covering the scattering sections on the rear surface of the light guide plate,
the method comprising:
a step of bonding a transparent sheet having a plurality of the scattering sections formed on a surface thereof to the rear surface of the substantially transparent light guide plate.

6. The method of manufacturing an edge light type illuminating device according to claim 5, wherein the scattering sections are formed on the transparent sheet by silk printing.

7. The method of manufacturing an edge light type illuminating device according to claim 5, wherein the scattering sections are formed on the transparent sheet by gravure printing.

8. The method of manufacturing an edge light type illuminating device according to claim 5, wherein the scattering sections are formed on the transparent sheet by relief printing.

9. The method of manufacturing an edge light type illuminating device according to claim 5, wherein the scattering sections are formed on the transparent sheet by offset printing.

10. The method of manufacturing an edge light type illuminating device according to claim 5, wherein the scattering sections are formed on the transparent sheet by inkjet printing.

11. A liquid crystal display device, comprising:
a liquid crystal panel; and
the edge light type illuminating device according to claim 1.

12. A television receiver comprising the liquid crystal display device according to claim 11.

13. A liquid crystal display device, comprising:
a liquid crystal panel; and
an edge light type illuminating device that is manufactured by the method of manufacturing an edge light type illuminating device according to claim 5.
